(19) United States
(12) Patent Application Publication
(10) Pub. No.: US 2010/0246871 A1
(43) Pub. Date: Sep. 30, 2010

(54) Portable Hearing Amplification System and Method

(76) Inventor: Victor Kingsun Wai, Hong Kong (HK)

Correspondence Address: Jellett Law, PS;Matthew Jellett, Esq., 910 Harris Ave, Suite A205, BELLINGHAM, WA, 98225, US

(21) Appl. No.: 12/415,457

(22) Filed: Mar. 31, 2009

(51) Int. Cl. H04R 25/00

(52) U.S. Cl. 381/323

(57) ABSTRACT

A hearing amplification system. The system has a rechargeable hearing amplifier and a portable charging system. The rechargeable hearing amplifier has a rechargeable battery, a sound amplification portion which will receive sound waves from between 200 to 6000 Hz amplifies sound waves to between 40 dB and 60 dB and broadcast the sound waves to a human user. The rechargeable hearing amplifier also has an ear engaging membrane which is designed to secure to a human ear. The amplification system also has a portable charging system to charge the rechargeable battery in the rechargeable hearing amplifier. The portable charging system has a single 1.5 V battery charger, and alternatively an AC adapter providing 3 V DC. The portable charging system has a seat for charging the rechargeable hearing amplifier and at least one seat for the ear engagement membrane.

### RELATED APPLICATIONS

This application claims priority benefit and fully incorporates by reference presently co-pending design patent applications of U.S. Ser. No. 29/328,353 filed Nov. 22, 2008 and U.S. Ser. No. 29/328,576 filed Nov. 26, 2008.

### BACKGROUND

Hearing Aides

U.S. Pat. No. 5,008,943 discloses a modular hearing aid with lid hinged to face plate where the module includes an open top battery compartment which is closed by a lid hinged to the face plate rather than to the module. The volume control on the module projects through an opening in the closed lid.

U.S. Pat. No. 6,438,296 discloses a compact modular in the ear hearing aid which has a hollow plug adapted to the ear canal and has a generally irregular conical shape and an exterior opening which is covered by faceplate and of which a recess is formed for a removable arrangement of battery as well as electronic module comprising microphone parts, signal processing part and a sound reproducer.

U.S. Pat. No. 6,556,870 discloses a partially inserted cochlear implant where a signal processor fits in the ear canal of a user. The signal processor processes an acoustic signal present in the ear of the user to produce a representative radio signal. Power transmitter transmits an electrical power signal from the skin of the user. A cochlear implant receives a radio signal and the electrical power signal and produces for the auditory nerve of the user an electrical stimulation signal representative of the acoustic signal.

U.S. Pat. No. 6,865,279 discloses a hearing aid with a flexible shell, where the hearing aid is assembled from three sections and includes the first section having a first housing containing a microphone and electronics, a second section having second housing containing a battery and flex circuit mounted around the battery and a third section having a compliant tip and receiver contained within a receptable end tip.

U.S. Pat. No. D141,071 discloses an earpiece for hearing aids.

U.S. Pat. No. D297,979 discloses a pair of hearing aids which seem to be the design ornamental configuration of the above partially inserted cochlear implant '870 patent.

U.S. Pat. No. D397,796 discloses a hearing aid which seems to be a main nonsymmetrical body and an angularly aligned cone shaped ear canal insert.

U.S. Pat. No. D554,756 discloses a hearing aid which has a single elliptically arranged cylindrical body with a single angularly aligned ear bud insert.

Chargers

U.S. Pat. No. 3,414,793 discloses a hearing aid battery charger where the charger includes a body portion and opposite parallel end walls. An electrically conducting strip extends along the end walls and along the body portion of the holder.

U.S. Pat. No. 3,579,075 discloses a compact battery charger for rechargeable batteries of various physical sizes and electrical capabilities.

U.S. Pat. No. 4,379,988 discloses a molded hearing aid in battery charger where the hearing aid is a self-containing type having a rechargeable battery disposed in the hearing aid casing. A light emitting diode is disposed through the external surface of plug and is externally connected in series with the iron core inductor with the series combination in parallel and with the internal chargeable battery. A battery charger is provided having a cup for receiving a molded plug and having a multi-turn coil wound around the periphery of the cup.

U.S. Pat. No. 5,210,804 discloses a solar powered hearing aid and re-energizing case, where the in the ear hearing aid has a rechargeable storage cell permanently connected and permanently situated within its shell and a solar cell which is carried on the back plate and facing outward. The solar cell provides power to energize the hearing aid amplifier while the device is worn and also re-energizes the storage cell for average ambient conditions.

U.S. Pat. No. 5,253,300 discloses a solar powered hearing aid which includes rechargeable batteries and contacts accessible from outside of the hearing aid casing for the battery. The charging case includes solar cells mounted on the charging case itself for output of energy to charge the batteries in the hearing aids.

U.S. Pat. No. 6,310,960 discloses a contact-less rechargeable hearing aid system which utilizes a rechargeable hearing aid which may be optically or inductively recharged by an optical or inductive re-charger. The optically rechargeable hearing aid may have a dual-purpose optical fiber that may act as a light conduit for the recharging light, and may also act as a drawstring for hearing aid. The rechargeable hearing unit uses a high-energy nickel metal hydride rechargeable battery or a high-energy high voltage lithium based rechargeable battery in conjunction with a DC to DC voltage regulating circuit for converting the rechargeable batteries declining DC output voltage to a fixed DC input voltage needed for the hearing aids audio related circuitry.

U.S. Pat. No. 6,658,124 discloses a rechargeable hearing aid which eliminates the requirement for frequent replacement of a disposable hearing aid battery. The rechargeable hearing aid features inductive recharging using a charging reservoir. In a preferred embodiment, the lithium ion battery is used with a completely in the canal hearing aid.

U.S. Pat. No. 7,062,057 discloses a rechargeable hearing aid which has a battery charger in a hearing aid body. The battery charger presents an easily carried case which is provided with a receiving groove and a battery chamber which contains a dry battery for power supply. The receiving groove can receive the hearing aid body and is provided with connection terminals at two sides of the inner groove for flexibly locking the hearing aid body. A cover on the receiving groove is pivotally connected to the battery charger by a hinge element which is further connected to a switch such that when the cover is in the position of off, the battery can start recharging right away and be quickly completed by the micro voltage charge.

U.S. Pat. No. 7,158,649 discloses a hearing aid storage case with hearing aid activity detection, the storage case itself is rectilinear, and the storage case detects and indicates presence of oscillating or quiescent activity of hearing aids. Within the storage case, there is transducer coupled to a logic circuit. The logic circuit is further coupled to one or more visual cues. The transducer picks up any sounds within the storage case and converts the sounds into electrical signals.

U.S. Pat. No. 7,349,741 discloses a cochlear implant sound processor with permanently integrated replenish-able power source where it is powered by a rechargeable battery that is permanently integrated into the sound processor. The sound processor contains an inductive coil that may be tuned to an external charging coil for battery recharging.

US 2008/0128007 discloses a portable apparatus for charging and cleaning hearing aid device, where the portable apparatus combines functions of charging and cleaning hearing aid devices into single unit.

### BRIEF DESCRIPTION OF THE DRAWINGS

FIG. 1 is an overall perspective view of the hearing amplifier system;

FIG. 2 is a schematic view of the rechargeable hearing amplifier inserted into the human ear;

FIG. 3 is a schematic system view of the hearing amplifier system;

FIG. 4 is an outside perspective view of the portable charging system;

FIG. 5 is an outside perspective view of the portable charging system with the lid open;

FIG. 6 is a perspective detailed view of the rechargeable hearing amplifier;

FIG. 7 is a bottom perspective view of the rechargeable hearing amplifier;

FIG. 8 is an elevational detail view of the rechargeable hearing amplifier;

FIG. 9 is a plan view of the charger circuit;

FIG. 10 is a plan view of the amplifier circuit;

FIG. 11 is a flowchart of the method for utilizing a hearing amplifier system.

### DESCRIPTION OF THE PREFERRED EMBODIMENTS

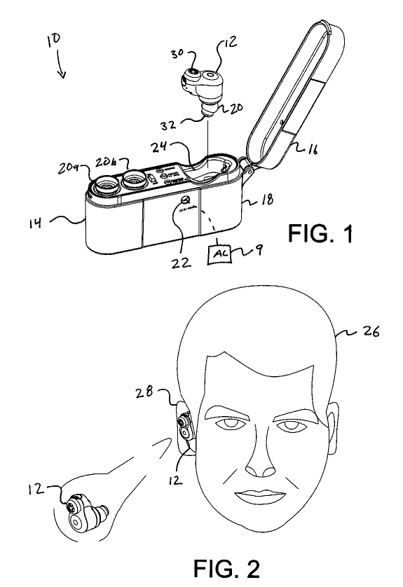

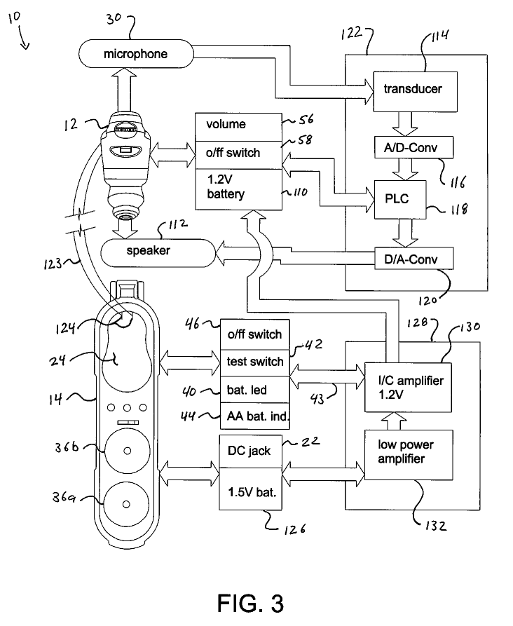

Generally speaking, referring to FIG. 1, what is provided is a hearing amplification system 10 which includes a rechargeable hearing amplifier and a portable charging system. The rechargeable hearing amplifier 12 is configured to seat within a human ear 28 as seen in FIG. 2, and as will be discussed below, the rechargeable hearing amplifier 12 has multifunction capabilities including a microphone 30 a sound port 32 and an ear engagement membrane for angled insertion into the user's 26 ear 28 for proper seating of the rechargeable hearing amplifier 12 during use. The portable charging system 14 is also a multifunction apparatus which is configured to hold and recharge the rechargeable hearing amplifier 12, a first ear engaging membrane 20A, a second ear engaging membrane 20B, as well as a 1.5 V battery 126 (FIG. 3) and also to receive power from an AC adapter providing 3 V charge in lieu of the 1.5 V battery charge.

A discussion of the overall system will now be provided in detail with primary reference to FIGS. 1 and 3. The rechargeable hearing amplifier 12 as utilized in the hearing amplifier system 10 makes use of a 1.2 V battery 110 which is an internal battery and in one embodiment is preferably an NI-MH rechargeable battery. This rechargeable battery can be accessed and charged by either the AC power adapter 9 which provides a DC charge of 3 V, or it can be charged by the 1.5 V AA battery 126 maintained within the portable charging system 14 in a removable battery compartment. When fully charged, the internal battery 110 will provide approximately 10 hours of continuous maximum use before it needs to be recharged.

The sound amplification portion is configured to receive physical sound waves and transform the sound waves which range between 200 to 6000 Hz in to analog signals. The sound amplification portion will amplify the digital sound waves to between 40 dB and 60 dB and then broadcast the amplified analog sound waves to a human user.

The sound application portion utilizes a microphone 30 which is electrically connected to an amplifier circuit 122. The amplifier circuit receives the analog sound wave signals from the microphone 30 and utilizes an analog audio transducer 114 which further transforms the sound wave signals reading between the range of 200 to 6000 Hz. The analog sound wave signals are then converted from analog to digital in an analog to digital converter 116. The analog to digital converter sends the digital sound wave signals to the programmable logic controller 118. The programmable logic controller 118 has multiple functions which include amplifying the digital sound signals to between 40 dB and 60 dB, sending and receiving on-off signals to and from the on-off switch 58, sending and receiving volume control signals from the volume controller 56 as well as sending the amplified digital signals to a digital to analog converter 120. The digital to analog converter 120 converts the amplified digital sound wave signals into amplified analog sound wave signals for broadcast through the speaker 112 and into the human ear 28.

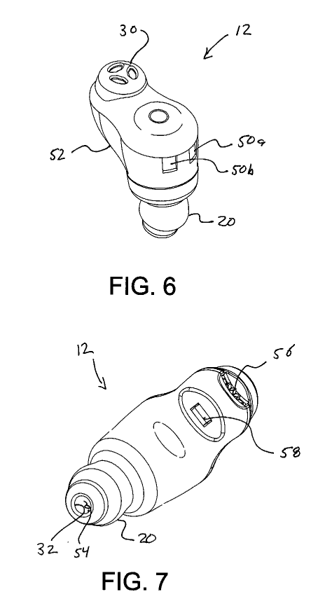

As previously discussed above, the portable charging system 14 which interoperates with the rechargeable hearing amplifier 12 has a portable power source which is configured to supply the rechargeable battery 110 of the rechargeable hearing amplifier 12 with a 1.5 V charge. The portable charging system 14 as a rechargeable hearing amplifier seat 24 with spring-loaded charger leads 124 for providing a recharge connection 123 to the rechargeable hearing amplifier 12 which has as seen in FIG. 6, charge terminals 50A and 50B on the posterior portion of the rechargeable hearing amplifier 12.

In order to provide for the proper current based on the individual power sources, those being the portable power source 126 which in one embodiment is the 1.5 V battery, or the 3 V DC power source 22 which comes from the AC adapter 9, a charger circuit 28 utilizes a low-power amplifier 132. The power is fed into the low-power amplifier 122 and modulated through the circuit to the integrated circuit amplifier 130 which provides a 1.2 V charge to the 1.2V battery 110. The integrated circuit amplifier also sends/receives charger circuit operating signals 43 to the on-off switch 46, the test switch 42, the battery charge LED 40, and the AA battery indicator 44.

If the AC power adapter 9 is providing power, then the integrated circuit amplifier 130 will switch to the constant alternating current power supply in lieu of the 1.5 V battery 126 to conserve the battery charge. If the portable charging system 14 is not plugged into an alternating current source, then the integrated circuit amplifier 130 will utilize the portable power source 126. The integrated circuit amplifier 130 will send the charge to the 1.2 V battery 110 within the rechargeable hearing amplifier 12 when the rechargeable hearing amplifier 12 is seated within the amplifier seat 24 and has a recharge connection 123.

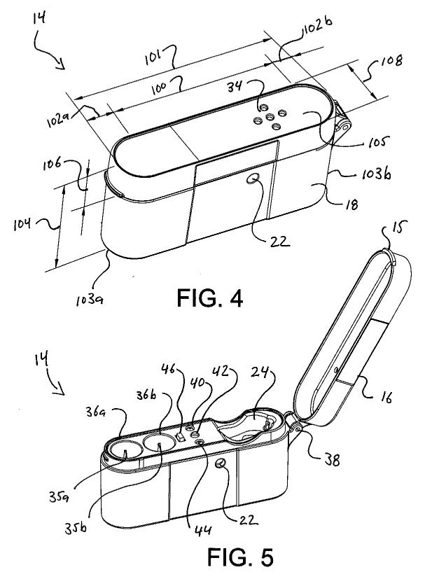

Now that a detailed discussion of the hearing amplifier system 1 0 has been provided, a discussion of the arrangement of the portable charging system 14 will now be provided as seen FIGS. 4 and 5. In this particular embodiment, the portable charging system 14 is constructed utilizing injection molded plastic but other materials are usually conceived such as wood, alloy, carbon, or other metallic material suitable for the purpose of the construction of the portable charging case 18 as seen in FIG. 1 and FIG. 4.

Referring to FIGS. 4 and 5, a detailed discussion of the construction of the portable charging casing body 18 will now be provided. In this particular embodiment, the case 18 is arranged in a substantially rectilinear cylinder with a casing length 101 which includes a main casing body length 100, a forward or front end 103A and a distal end 103B where the forward and distal ends are each chamfered in a semicircular cylindrical fashion having a length 102A and 102B which is the radial distance from the center of the semicircular cylinder. In general, the casing length 101 is approximately 9.21 cm in length with the main body section approximately 6.65 cm and the two chamfered ends approximately 1.28 cm in radial distance. The case lid 16 has a plurality of heat vents 34 which are as previously discussed are arranged above the rechargeable hearing amplifier seat 24 in which are holes in the top wall 105 of the case lid 16. The case 18 has an overall casing height 104 which is approximately 4.3 cm and the case has a casing width 108 which is approximately 2.36 cm. The casing lid height 106 is approximately 1.15 to 1.2 cm. At the distal end 103B is arranged a single lid hinge 38 which enables the case lid 16 to operably open and close onto the main portion of the body. The casing lid 16 is semi translucent, while the lower portion of the case is opaque.

The ear engagement membrane seats 36A and 36B are arranged in semi spherical concave indentations into the top wall of the case. Extending vertically upwards are seat stays 35A and 35B which are elongated conical shaped stays for receiving the ear engagement membranes and holding them place. Towards the middle portion of the main casing body is located the on-off switch 46, the charge LED light 40, the test battery capacity switch 42, and the AA battery LED indicator 44. The AC plug port 22 is arranged in the sidewall of the casing. On the bottom wall of the casing (not seen) is an access hatch for the insertion of the AA battery into the battery space.

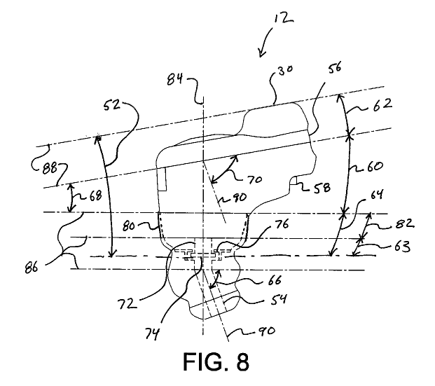

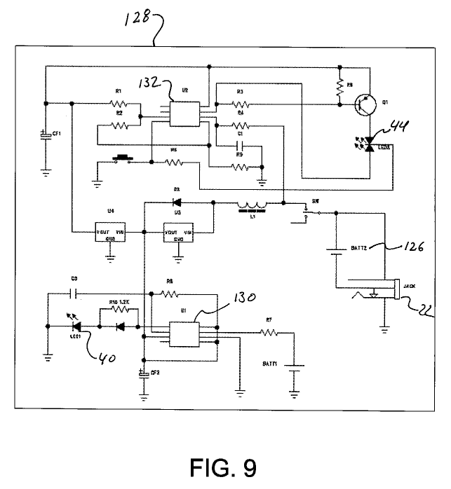

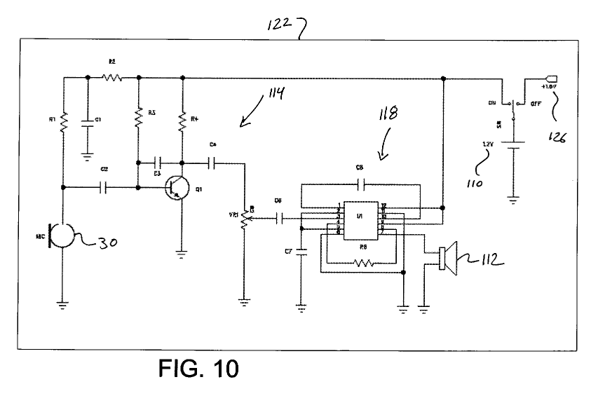

A detailed discussion of the rechargeable hearing amplifier 12 will now be provided as seen in FIGS. 6, 7, and 8. Discussion will be provided on the overall orientation as well as the interoperation between the sound amplification portion 52 and the ear engagement membrane 20. The rechargeable hearing amplifier 12 is made of two main parts, the sound amplification portion 52 and the ear engagement portion or membrane 20. The sound amplification portion 52 includes the operational controls including the volume control 56 which in one embodiment is a dial (in other embodiments can be a switch for low, medium and high), an on-off switch 58, a microphone/sensor, 30, and a speaker 112 which is encased within the body portion of the sound amplification.

The sound amplification portion 52 is arranged along a longitudinally aligned axis 84. This longitudinally aligned axis is substantially perpendicular to a transverse axis 86. At an offset angle or otherwise known as sound amplification angle 68 of about 10°, is an upper body radial axis 88. The upper body radial axis defines the angle at which the upper body portion 62 of the sound amplification portion 52 is arranged for proper orientation during wear by the user. Transitioning between the upper body radial axis 88 and the transverse axis 86 is a mid-body portion 60. The mid-body portion includes the on-off switch 58 plus the battery and speaker. Below the mid-body portion 60 is a lower body portion 64. The lower body portion 64 is configured to interoperate with the ear engagement membrane 20. The lower body portion 64 has a larger diameter lower body portion 82. This larger diameter portion 82 interoperates with an outer collar 80 of the ear engagement membrane or portion 20.

The ear engagement membrane 20 in one embodiment is constructed of a silicone material for user comfort when inserted into the user's ear. While silicone is the current embodiment material, additional materials may also be utilized including rubber, plastic, foam, or a combination of materials above listed for desired comfort and utility.

The lower body portion 64 also has a male membrane connector 72 which is cylindrically arranged to provide an airspace medium through which the sound waves can propagate to exit from the speaker broadcast. In other words, the male membrane connector 72 acts as a speaker port 74 for transmission of the sound waves.

The ear engagement membrane 20 is constructed so that it has a bulging cylindrical midsection and a tapered cylindrical head. Through the center of the ear engagement membrane 20 is a sound wave conduit 54 which continues the airspace medium passage from the speaker port 74 of the lower body portion of the sound amplification portion, so that the sound waves can further propagate to reach the inner ear of the user.

About the midpoint of the bulging section of the ear engagement membrane, the ear engagement membrane transitions from being aligned about the longitudinally aligned axis 84 to follow an ear engaging radial axis 90 which is at an offset angle or ear engagement angle 66 of approximately 70° negative from the transverse axis 86 when connected to the sound amplification portion. The combination of the ear engagement angle 66 and the sound amplification angle 68 form a total amplification angle 70 of approximately 80° provides for a generally concave angled arrangement enabling the rechargeable hearing amplifier 12 to be seated comfortably within a user's ear and have the microphone 30 positioned properly to receive sound waves as they approach the user's ear.

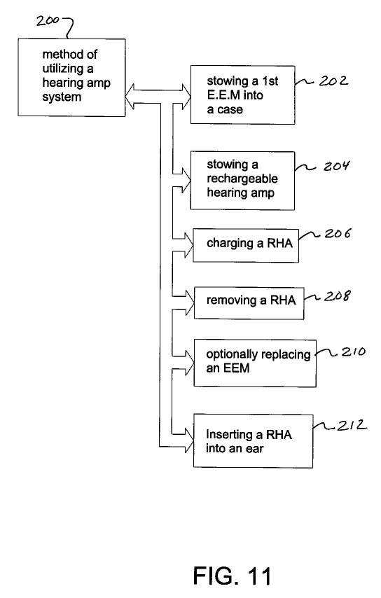

A method of utilization of the hearing amplification system 200 as seen in FIG. 11 will now be discussed. In order to properly utilize the hearing application system 10, the user may follow the following steps.

The user may first stow in step 222 a first ear engagement membrane 20 into a case 18 of the portable charging system 14 by opening the lid 16 and inserting the ear engagement membrane into the ear engagement membrane seat 36A or 36B.

The user may also decide to stow in step 204 the rechargeable hearing amplifier 12 by placing it into the rechargeable hearing amplifier seat 24. Optionally, the user may leave on the pre-existing ear engagement membrane or may take it off i.e. remove the ear engagement membrane and stow it in the second ear engagement membrane seat 36B.

At step 206, the user may then decide to charge the rechargeable hearing amplifier 12 by actuating the on-off switch 46 to turn on the power for charging the 1.2 V battery 110. At this point, the user may be utilizing the hearing amplification system 10 in a portable fashion so that the user is relying upon utilizing a 1.5 V amp battery 126 to recharge the rechargeable hearing amplifier 12.

If the battery is not installed into the portable charging system 14, the user may utilize the AC adapter 9 and recharge the rechargeable hearing amplifier 12 with the 3 V adapted charge. In order to make sure that the rechargeable hearing amplifier is properly charged the user will align the spring-loaded charger leads 124 with the charged terminals 50A & 50B located on the rechargeable hearing amplifier to ensure proper connection.

Once the rechargeable hearing amplifier is completely charged, the user can remove the rechargeable hearing amplifier at step 208 from the portable charging system 14 by forcing the case lid 16 open.

The user can optionally replace the ear engaging membrane at step 210 by utilizing the first ear engaging membrane 20A located in the first ear engaging membrane seat 36A and slide the collar 80 of the ear engaging membrane over the large diameter lower body portion 82 of the sound amplification portion and also subsequently engage the male ear engaging connector 72 with the female receptor 76 to lock the ear engaging membrane 20 into place thus replacing the old ear engagement portion 20 with the new ear engagement portion.

Lastly, the user can insert the rechargeable hearing amplifier into an ear at step 212 by first turning on the rechargeable hearing amplifier, adjusting the volume, amplifying the sounds and then orientating the rechargeable hearing amplifier for maximum use of the total amplification angle 70.

Therefore I claim:

1. A hearing amplification system, said system comprising:
a. a rechargeable hearing amplifier comprising;
i. a rechargeable battery configured to provide power to said rechargeable hearing amplifier;
ii. a sound amplification portion configured to receive sound waves, transform said sound waves into sound wave signals ranging between about 200 to about 6000 Hz, amplify said sound wave signals to between 40 dB to 60 dB, convert said amplified sound wave signals into amplified sound waves for broadcast to a human user;
iii. a first ear engagement membrane configured to maintain a secure seat in a human ear;
b. a portable charging system comprising:
i. a portable power source configured to supply said rechargeable battery of said rechargeable hearing amplifier a charge;
ii. a first charging seat configured to operably charge said rechargeable hearing amplifier;
iii. a first ear engagement membrane seat configured to stow said first ear engagement membrane.

2. The system according to claim 1 wherein said rechargeable battery further comprises: a 1.2 V internal NI-MH rechargeable battery.

3. The system according to claim 1 wherein said portable power source further comprises: a 1.5 V AA battery.

4. The system according to claim 3 wherein said portable power source further comprises: an AC power adapter with a 3 V DC output.

5. The system according to claim 4 wherein said system further comprises: said 1.5 V AA battery configured as a rechargeable lithium-ion battery, said AC power adapter configured to recharge said 1.2 V internal battery, said 1.5 V AA battery.

6. The system according to claim 1 wherein said sound amplification portion further comprises: a microphone configured to transform said sound waves into said sound wave signals.

7. The system according to claim 6 wherein said sound amplification portion further comprises: an analog audio transducer configured to transmit said analog sound wave signals ranging from between about 200 Hz to about 6000 Hz.

8. The system according to claim 7 wherein said sound amplification portion further comprises: an analog to digital sound wave converter configured to convert said analog sound wave signals to digital sound wave signals.

9. The system according to claim 8 wherein said sound amplification portion further comprises: a programmable logic controller configured to amplify said digital sound wave signals from between about 40 dB to about 60 dB.

10. The system according to claim 9 wherein said sound amplification portion further comprises: a digital to audio sound wave signal converter configured to convert said amplified digital sound wave signals to amplified analog sound wave signals.

11. The system according to claim 10 wherein said sound amplification portion further comprises: a speaker configured to broadcast said amplified analog sound wave signals to said human user as amplified sound waves.

12. The system according to claim 9 wherein said sound amplification portion further comprises: a volume control component, an on/off switch.

13. The system according to claim 1 wherein said first ear engaging membrane further comprises: a silicone material.

14. The system according claim 13 wherein said first ear engaging membrane further comprises: a collar for interoperable engagement with said sound amplification portion, a sound wave conduit for transmission of said amplified sound waves through said ear engaging membrane and into said user's or said human ear.

15. The system according claim 1 wherein said rechargeable hearing amplifier further comprises: said sound amplification portion arranged about a centrally aligned longitudinal axis, a transversely aligned axis, and an upper body radial axis, said sound amplification portion further comprising a lower body portion circumferentially arranged about said longitudinally aligned axis and radially parallel with said transverse axis.

16. The system according to claim 15 wherein said sound amplification portion further comprises: a transitional mid-body portion arranged to transition from said lower body portion circumferentially arranged about said longitudinally aligned axis and parallel with said transverse axis to an upper body radially aligned axis having a sound amplification angle about 10° positive from said transverse axis.

17. The system according to claim 16 wherein said sound amplification portion further comprises: an upper body portion arranged parallel with said upper body radial axis and configured to maintain said microphone.

18. The system according to claim 17 wherein said sound amplification portion further comprises: a lower body portion configured to interoperate with said ear engaging membrane.

19. The system according to claim 18 wherein said lower body portion further comprises: a speaker port for transmission of said amplified sound waves to said sound wave conduit of said ear engagement membrane.

20. The system according to claim 19 wherein said speaker port is further configured as a male connector to interoperate with a female receptor configured within said ear engaging membrane.

21. The system according claim 20 wherein said speaker port is further configured as a male connector and said sound wave conduit is further configured as a female receptor, said male connector configured to interoperably connect with said female receptor to maintain said ear engagement membrane in an interoperable position with said sound amplification portion.

22. The system according to claim 21 wherein said sound amplification portion further comprises: a charge terminal for interoperation with charging leads configured within said portable charging system to transmit said charge from said portable power source to said rechargeable battery.

23. The system according to claim 1 wherein said portable charging system further comprises: a second ear engagement membrane seat configured to stow a second ear engagement membrane.

24. The system according to claim 1 wherein said portable charging system further comprises: a charger circuit configured to send and receive charging circuit operation signals.

25. The system according to claim 24 wherein said charging circuit operation signals further comprise an on/off signal, a test signal, a charged battery signal, a AA battery indication signal.

26. The system according claim 25 wherein said portable charging system further comprises: said charger circuit configured to receive a current from either a 3 V power source or a 1.5 V battery source, said charger circuit configured to amplify said current to recharge a 1.2 V battery.

27. The system according to claim 26 wherein said portable charging system further comprises: a low power amplifier configured to receive said current from either a 3 V power source or a 1.5 V battery power source for transmission to a 1.2 V integrated circuit amplifier, said 1.2 V integrated circuit amplifier configured to send a charge to said 1.2 V rechargeable battery when said rechargeable hearing amplifier is seated within said rechargeable hearing amplifier seat so that a recharge connection exists between said portable charging system and said rechargeable hearing amplifier.

28. The system according to claim 25 wherein said portable charging system further comprises: an on/off switch configured to send said on/off signal to said charging circuit, a test switch configured to send said test signal to said charging circuit, a charged battery LED configured to receive said charged battery signal from said charging circuit, a AA battery indication LED configured to receive said AA battery indication signal from said charging circuit.

29. The system according claim 27 wherein said portable charging system further comprises: a spring-loaded charger lead for transmission of said recharge current to said rechargeable hearing amplifier.

30. The system according claim 1 wherein said portable charging system further comprises a portable charging case comprising a hinged lid, said hinged lid comprising heat dissipation vents for dissipation of heat built up during recharge of said rechargeable battery.

31. The system according claim 30 wherein said portable charging system further comprises: said portable charging case further comprising a casing link comprised of a rectilinear main body casing, said rectilinear main body casing comprising a front end and a distal end configured to chamfer said rectilinear main casing body in semi-cylindrical configuration, said rectilinear main body casing further comprising a casing height, a casing width.

32. The system according claim 31 wherein said portable charging case further comprises: said casing length comprising a length no greater than approximately 10 cm; said casing width comprising a width no greater than approximately 2.5 cm; said casing height comprising a height no greater than approximately 10.5 cm.

33. A method of utilizing a hearing amplification system, said method comprising:
a. storing a first ear engaging membrane into a case comprising a first membrane seat, a second membrane seat, and a recharge seat;
b. stowing a rechargeable hearing amplifier into said recharge seat; said rechargeable hearing amplifier comprising a sound amplification portion, an ear engaging portion
c. charging said rechargeable hearing amplifier in said recharge seat;
d. removing said rechargeable hearing amplifier from said case when charging is complete;
e. optionally replacing said ear engaging portion with said first ear engaging membrane;
f. installing said rechargeable hearing amplifier into a human ear.

34. The method according to claim 33 wherein said method further comprises:
storing said first ear engaging membrane onto a first stay arranged within said first membrane seat; said second membrane seat comprising a second stay for interoperable receipt of a second ear engaging membrane.

35. The method according to claim 34 wherein said stowing a rechargeable hearing amplifier further comprises: removing said ear engaging portion from said rechargeable hearing amplifier and placing said ear engaging portion onto said second membrane seat.

36. The method according claim 33 wherein said stowing a chargeable hearing amplifier further comprises:
a. aligning a set of spring-loaded charger leads with a set of charger terminals located on said rechargeable hearing amplifier;
b. placing said rechargeable hearing amplifier into said recharge seat located within said case;
c. connecting said set of spring-loaded charger leads with said set of charger terminals to establish a recharge connection.

37. The method according claim 36 wherein charging said rechargeable hearing amplifier further comprises: utilizing a 1.5 V AA battery within said case to charge said rechargeable hearing amplifier.

38. The method according to claim 36 wherein charging said rechargeable hearing amplifier further comprises: utilizing a 3 V DC current from an AC power adapter to charge said rechargeable hearing amplifier.

39. The method according to claim 37 wherein said charging said rechargeable hearing amplifier further comprises: testing said 1.5 V AA battery to determine an available charge.

40. The method according to claim 39 wherein said charging said rechargeable hearing amplifier further comprises: replacing said 1.5 V AA battery if no charges is available as determined by said testing of said 1.5 V AA battery.

41. The method according to claim 33 wherein said optionally replacing said ear engaging portion further comprises: installing said first ear engaging membrane onto said sound amplification portion by:
a. sliding a collar of said ear engaging membrane over a lower body portion of said sound amplification portion;
b. engaging a male connector portion on said sound amplification portion with a female receptor portion within said ear engaging membrane;
c. securing said ear engaging membrane to said sound amplification portion thus providing said ear engaging membrane as said ear engaging portion of said rechargeable hearing amplifier.

42. A hearing amplification system, said system comprising:
a. means for storing a first ear engaging membrane into a case comprising a first membrane seat, a second membrane seat, and a recharge seat;
b. means for stowing a rechargeable hearing amplifier into said recharge seat; said rechargeable hearing amplifier comprising a sound amplification portion, an ear engaging portion
c. means for charging said rechargeable hearing amplifier in said recharge seat;
d. means for removing said rechargeable hearing amplifier from said case when charging is complete;
e. means for optionally replacing said ear engaging portion with said first ear engaging membrane;
f. means for installing said rechargeable hearing amplifier into a human ear.

43. The system according to claim 42 wherein said system further comprises:
means for storing said first ear engaging membrane onto a first stay arranged within said first membrane seat; said second membrane seat comprising a second stay for interoperable receipt of a second ear engaging membrane.

44. The system according to claim 43 wherein said means for stowing a rechargeable hearing amplifier further comprises: means for removing said ear engaging portion from said rechargeable hearing amplifier and means for placing said ear engaging portion onto said second membrane seat.

45. The system according claim 42 wherein said stowing a chargeable hearing amplifier further comprises:
a. aligning a set of spring-loaded charger leads with a set of charger terminals located on said rechargeable hearing amplifier;
b. placing said rechargeable hearing amplifier into said recharge seat located within said case;
c. connecting said set of spring-loaded charger leads with said set of charger terminals to establish a recharge connection.

46. The system according claim 45 wherein charging said rechargeable hearing amplifier further comprises: means for utilizing a 1.5 V AA battery within said case to charge said rechargeable hearing amplifier.

47. The system according to claim 45 wherein means for charging said rechargeable hearing amplifier further comprises: means for utilizing a 3 V DC current from an AC power adapter to charge said rechargeable hearing amplifier.

48. The system according to claim 46 wherein said means for charging said rechargeable hearing amplifier further comprises: means for testing said 1.5 V AA battery to determine an available charge.

49. The system according to claim 48 wherein said means for charging said rechargeable hearing amplifier further comprises: means for replacing said 1.5 V AA battery if no charges is available as determined by said testing of said 1.5 V AA battery.

50. The system according to claim 42 wherein said means for optionally replacing said ear engaging portion further comprises: means for installing said first ear engaging membrane onto said sound amplification portion by:
a. means for sliding a collar of said ear engaging membrane over a lower body portion of said sound amplification portion;
b. means for engaging a male connector portion on said sound amplification portion with a female receptor portion within said ear engaging membrane;
c. means for securing said ear engaging membrane to said sound amplification portion thus providing said ear engaging membrane as said ear engaging portion of said rechargeable hearing amplifier.
